(19) United States
(12) Patent Application Publication
(10) Pub. No.: US 2026/0170089 A1
(43) Pub. Date: Jun. 18, 2026

(54) METHOD OF PROVIDING CLASSIFICATION DATA, METHOD OF TRAINING A CLASSIFICATION SYSTEM, CONTROL DEVICE, PROGRAM AND DATA STORAGE

(71) Applicant: AUMOVIO Autonomous Mobility Germany GmbH, Ingolstadt (DE)

(72) Inventor: Patrick Hatzelmann, Lindau (DE)

(73) Assignee: AUMOVIO Autonomous Mobility Germany GmbH, Ingolstadt (DE)

(21) Appl. No.: 19/371,314

(22) Filed: Oct. 28, 2025

(30) Foreign Application Priority Data
Oct. 30, 2024 (DE) 102024210475.2

(51) Int. Cl. G06F 18/241; G06F 18/213

(52) U.S. Cl. CPC G06F 18/241; G06F 18/213

(57) ABSTRACT

A method for providing classification data for the classification of a target object based on detection in received radar signals. The method includes the following steps carried out by a control device: receiving the radar data of a current scanning cycle of a detection track, which includes the detection of a detection track associated with the target object; extracting at least one predefined input feature from the detection in the radar data of the current scanning cycle; providing the at least one input feature of the current scanning cycle to a feature generation model of a classification system; updating an internal state of the feature generation model based on the at least one input feature of the current scanning cycle; providing at least one temporal feature to a classification model of the classification system; outputting the classification data based on the at least one temporal feature by the classification model.

### CROSS REFERENCE TO RELATED APPLICATIONS

This application claims priority to German Application No. 10 2024 210 475.2, filed Oct. 30, 2024, the contents of such application being incorporated by reference herein.

### FIELD OF THE INVENTION

The invention relates to a method for providing classification data for classifying a target object on the basis of detection in received radar signals, to a method for training a classification system, to a control device, to a program and to a data storage.

### BACKGROUND OF THE INVENTION

Environment detection systems for vehicles comprise a sensor device that is configured to detect an environment of the vehicle. Further evaluations take place on the basis of detection data from the sensor device, for example in order to classify objects in the detection data.

The detection of the environment can be carried out, for example, by means of radar, wherein radar signals are emitted by the sensor device and radar signals reflected at a target object (target) are received. In the reflected radar signals, the target object can be detected as a detection. Radar-based sensor devices are used, for example, for obstacle identification, wherein target objects are checked for whether they constitute an obstacle for the vehicle. A target object can be classified as an obstacle if it cannot be passed over by the vehicle or cannot be passed under by the vehicle. A target object that can be passed over can be, for example, a manhole cover or a lowered curb stone. An object that cannot be passed over can be, for example, a boundary stone. A target object that cannot be passed under can be, for example, a bridge with a reduced depth.

In contrast to lidar signals which are detected by lidar-based sensor devices, the radar signals have a relatively low lateral and vertical resolution. This makes it difficult to determine whether the target object is an obstacle in certain situations. In a classification method based on the detection data, it is therefore necessary to carry out additional evaluations.

U.S. Pat. No. 10,611,371 B2, incorporated herein by reference, describes a system and method for predicting the lane change of vehicles using structural recurrent neural networks.

U.S. Pat. No. 11,726,477 B2, incorporated herein by reference, describes methods and systems for trajectory prediction with recurrent neural networks using inertia behavior roll-out.

US 2023 0184921 A1, incorporated herein by reference, describes a radar point cloud-based posture determination system.

US 2022 0198808 A1, incorporated herein by reference, describes a method and an apparatus for detecting obstacles, a computer device and a storage medium.

U.S. Pat. No. 11,594,011 B2, incorporated herein by reference, describes a deep learning-based feature acquisition for the Lidar localization of an autonomous vehicle”

DE 10 2018 217 533 A1, incorporated herein by reference, describes a classification by means of RCS signals measured by radar and the interference patterns thereof. In this method, a history of the measured RCS values of a target is approximated using a linear function, and features derived therefrom, such as mean error, gradient, etc., are used for the actual classification. The aim of the classification is to divide targets measured using the derived features into the classes “passable” and “obstacle”.

The approximation of the history of the detections (e.g. RCS) of a target object detected in radar signals by means of a linear function has the disadvantage that a lot of information is lost. This may result in a reduction in the classification performance. For example, it is not possible, or only to a limited extent, to distinguish between ground targets (e.g. manhole cover, beverage can, etc.) that can be passed over from low but non-passable obstacles (e.g. Euro pallet, etc.) on the basis of the detections. In the worst case, this can lead to a malfunction in the vehicle (incorrect braking or no reaction).

### SUMMARY OF THE INVENTION

An aspect of the present invention aims to carry out a classification of target objects directly on the basis of measured radar signals without using processed features, which is precise enough to distinguish also target objects of very similar height.

An aspect of the invention, in particular, aims to determine on the basis of the detections detected in the radar signals, without using processed features such as for example features derived from a linear function approximation, a classification of the detections which is precise enough to be able to distinguish also target objects of very similar height from one another.

This aspect is achieved by the entire teaching of claim 1 and of the other independent claims. Expedient configurations of aspects of the invention are claimed in the dependent claims.

A first aspect of the invention relates to a method for providing classification data for classifying a target object on the basis of detections in received radar signals. The classification data are intended to classify a target object reproduced by the detections in the received radar signals. The classification comprises an association of the target object with at least one predefined output class.

The method comprises the following method steps carried out by a control device.

A first step comprises receiving the radar data of a current scanning cycle. The radar data comprise detections that are associated with the target object by the radar tracker. The radar data can be based on received radar signals from the current scanning cycle. In other words, the radar data relate to a quality of the received radar signals of the current scanning cycle. The radar data describe the detections present in the radar signals, which were associated with the target object by the radar tracker. There may be provision that the radar signals are emitted by a sensor device and reflected radar signals are received in the respective scanning cycle. The reflected radar signals can include the detections that can be attributed to reflections by the target object. The relevant detections can be identified by the radar tracker in the respective reflected radar signals and can be described in the radar data of the respective scanning cycle, which are provided to the control device.

A further step comprises extracting at least one predefined input feature from the detections of the radar signal of the current scanning cycle. In other words, the radar data of the current scanning cycle are evaluated by the control device and in the process the at least one predefined input feature is extracted.

In a further step, the at least one input feature of the current scanning cycle is provided to a feature generation model of a classification system. The feature generation model has an internal state which represents the at least one input feature from preceding scanning cycles of the detection track. The feature generation model is configured to output at least one predefined temporal feature on the basis of the internal state and the at least one input feature of the current scanning cycle. In other words, it is provided that the at least one input feature of the scanning cycles is provided to the feature generation model. The feature generation model has the internal state depending on the at least one input feature of preceding scanning cycles. The internal state thereby represents a history of the at least one input feature of the preceding scanning cycles of the detection track.

The internal state of the feature generation model is updated on the basis of the at least one input feature of the current scanning cycle. On the basis of the internal state and the at least one input feature of the current scanning cycle, the at least one predefined temporal feature is output by means of the feature generation model. The temporal feature is a feature which depends on the internal state and which can therefore describe the history of the at least one predefined input feature.

The at least one temporal feature is provided to a classification model of the classification system. The classification model is configured to output classification data relating to an association of the target object with at least one predefined output class on the basis of the at least one temporal feature. In other words, the at least one predefined output class is predetermined. The classification model is configured to determine the classification data which describe an association of the target object with the at least one output class. The classification data can for example describe whether the target object that is associated with the at least one temporal feature is associated with the output class.

A further step comprises outputting the classification data on the basis of the at least one temporal feature by means of the classification model. The output can be provided to a driving assistance system of the vehicle, for example.

An advantage of an aspect of the invention is that the history is not evaluated by an algorithm, such as a fit on a profile of the at least one input feature, but rather by the history by which the at least one temporal feature is represented. As a result, more aspects of a profile of the at least one input feature can be taken into consideration than is customary in other methods according to the prior art.

One aspect of the invention provides that the classification data comprise respective probability values relating to a probability of an association of the target object with the at least one predetermined output class. In other words, the classification data comprise information about how probable it is that the target object can be associated with the at least one predefined output class. Provision may be made, for example, for the probability values to describe the probability with which the target object is to be associated with an output class of the ground targets that can be passed over and the probability with which the target object can be associated with the output class of the ground targets that cannot be passed over. The probability values can be normalized in such a way that a sum of the probability values of the respective output classes results in one or 100%. The development results in the advantage that, by using probabilities, reliability of the association can be estimated.

One aspect of the invention provides that the feature generation model is in the form of an artificial recurrent neural network (RNN). An artificial recurrent neural network (RNN) is a type of artificial neural network that is able to process temporal or sequential data by storing information from the past and using that information in future calculations. Unlike feed-forward neural networks, where data flows in only one direction, RNNs allow communication between neurons in both directions and even within the same level of the network. This architecture allows the network to store information about a sequence of inputs and use this as a basis to make predictions for the future sequence. An RNN thus has a kind of “storage” called a context vector, which is generated from the previous inputs in the sequence. With each new input, the network updates the context vector by combining the new input with the previous context vector. This allows the network to track information about the entire sequence and take that information into account in the output. The feature generation model is designed such that, based on its internal state, it outputs at least one temporal feature which represents the internal state. The internal state of the feature generation model depends on a history of the at least one input feature from preceding scanning sequences. That is to say, the feature generation model processes a sequence of the at least one input feature and generates the temporal feature that summarizes or abstracts the context of the sequence of the input feature.

One aspect of the invention provides that the classification model is in the form of an artificial neural network (ANN). An artificial neural network is a machine learning model modeled after the human brain. It consists of a predetermined number of interconnected nodes or neurons. The classification model is designed such that, on the basis of the at least one temporal feature, it outputs the classification data relating to an association of the target object with the at least one predefined output class. That is to say, the classification model receives one or more of the temporal features and, on the basis of these, produces a prediction about the inclusion of the target object in the determined output class. The use of an artificial neural network as a classification model enables the creation of complex association functions that are able to detect non-linear relationships between the temporal feature and the output class.

One aspect of the invention provides that several of the input features of the current scanning cycle are extracted from the radar data of the current scanning cycle. There is provision for the input features to be scaled according to respective scaling factors in the feature generation model. In other words, the extraction comprises a determination of several of the input features from the radar signals, such as for example the distance, speed, direction and size of targets or surfaces. These input features are identified and selected on the basis of predefined criteria and algorithms and provided to the feature generation model. Scaling can be effected through the application of scaling factors that are matched to the properties and requirements of the feature generation model. The scaling factors can comprise, for example, standardization, normalization or min-max scaling, which permits the feature values of the input features to be converted into a uniform range. By using these scaling factors, differences in the units of measurement and orders of magnitude of the input features are eliminated and a better comparability and combination of the data is ensured.

An aspect of the invention provides that the at least one input feature of the current scanning cycle comprises a radar cross-section of the target object. Radar cross-section is a measure of the target's ability to reflect and bounce back radar waves. It is defined as the projected area of the target object in the direction of the incoming radar waves and depends on the geometric properties and material properties of the target object. The use of the radar cross-section as an input feature in the current scanning cycle can enable more precise and reliable detection of the target object. The radar cross-section can be used, for example, to determine the distance, size and orientation of the target object.

An aspect of the invention provides that the at least one input feature of the current scanning cycle comprises a height of detection above the ground. The height of detection above the ground comprises information about a spatial position and extent of the detection. By using the height as an input feature, a more accurate and reliable classification of the detection can be made possible, in terms of passing over and/or passing under. The ground can be determined by applying suitable algorithms and methods such as digital surface modeling (DSM). The ground can describe, for example, a surface of a road in front of the vehicle, which surface can be identified in the radar data.

An aspect of the invention provides that the height above the ground is calculated according to the formula h=sin(γ)*r+p, wherein h is the height above the ground, γ is the elevation angle of the detection, r is the radial distance of the detection and p is the vertical installation position of the radar sensor.

An aspect of the invention provides that a separate classification entity of the classification system is used for each of the target objects. In other words, it is provided that multiple target objects are classified in the method. It is provided here that the respective classification entity of the classification system is provided for each of the target objects. The respective classification entity has a respective feature generation model and a respective classification model, which are used separately for the respective target object.

An aspect of the invention provides that the method comprises an output of a control signal by the control device. In other words, it is provided that the control device outputs the control signal on the basis of the classification data. The control signal can be output, for example, when the target object is associated with a particular one of the output classes. For example, it may be provided that the control signal is output when the target object is classified as not passable over in order to initiate a reaction such as an intervention in vehicle guidance or an output of a warning signal to a driver of the vehicle.

A second aspect of the invention relates to a method for training a classification system.

The method for training the classification system comprises at least training a feature generation model which is trained to output at least one predefined temporal feature on the basis of an internal state of the feature generation model and at least one input feature.

In addition, the method for training the classification system comprises training a classification model which is trained to output, on the basis of at least one temporal feature, classification data relating to an association of a target object with at least one predefined output class. In other words, the described method for training a classification system comprises two main parts: the training of a feature generation model and the training of a classification model.

The training of the feature generation model comprises learning to output at least one predefined temporal feature on the basis of an internal state of the feature generation model and at least one input feature. This means that the feature generation model should learn to generate an internal representation of the input features that is useful for the classification model. The feature generation model may be an RNN which is trained to transform time sequences from input features into internal states which can then be used as inputs for the classification model.

The training of the classification model comprises the learning to generate, on the basis of at least one temporal feature, classification data which relate to the association of a target object with at least one predefined output class. The classification model is thus trained to make a decision regarding the output class of the target object on the basis of the temporal features generated by the feature generation model.

In addition to the training of the feature generation model, the method also comprises training the classification model, which learns to generate classification data directly from the temporal features.

Overall, the object of this method for training a classification system is thus to create models that are capable of making associations of target objects with output classes on the basis of input features. By training the feature generation model and the classification model, it is possible to ensure that the models produce suitable internal representations of the data and are robust with respect to different input features and output classes.

For instances of use or application situations which may arise in the course of the methods and which are not explicitly described here, provision may be made for an error message and/or a request to input a user feedback to be output and/or for a default setting and/or a predetermined initial state to be set according to the respective method.

A third aspect of the invention relates to a control device which is configured to carry out a method for providing classification data for classifying a target object on the basis of received radar signals according to the first aspect of the invention. Additionally or alternatively, the control device is set up for carrying out a method for training a classification system according to the second aspect of the invention.

In order to carry out the described steps, a processor circuit can be provided, which has programming or software that comprises program instructions which, when executing the program instructions, prompts the processor circuit to carry out an embodiment of the method. To this end, the processor circuit may have at least one microprocessor and/or microcontroller. The program instructions can be stored in a data storage of the processor circuit.

A fourth aspect of the invention relates to a program that comprises program instructions which, when executing the program instructions, prompt the processor circuit to carry out an embodiment of one of the methods.

A fifth aspect of the invention relates to a data storage that comprises program instructions which, when executing the program instructions, prompt the processor circuit to carry out an embodiment of one of the methods.

An aspect of the invention also includes developments of the control device according to an aspect of the invention, the computer program according to an aspect of the invention and the storage medium according to an aspect of the invention which have features as have already been described in connection with the developments of the methods according to an aspect of the invention. For this reason, the corresponding developments of the control device according to an aspect of the invention, of the computer program according to an aspect of the invention and of the storage medium according to an aspect of the invention are not described again here.

An aspect of the invention also comprises the combinations of the features of the described embodiments.

### BRIEF DESCRIPTION OF THE DRAWINGS

In the following, an exemplary embodiment of the invention will be described. In particular:

FIG. 1 shows a schematic representation of a vehicle which has a control device;

FIG. 2 shows a schematic representation of a course of radar cross-sections of different target objects over a distance.

FIG. 3 shows a schematic representation of a classification system of the control device;

FIG. 4 shows a schematic representation of results of the classification model;

FIG. 5 shows a schematic representation of a sequence of a method for providing classification data for classifying a target object on the basis of received radar signals; and

FIG. 6 shows a schematic representation of a method for training a classification system.

### DETAILED DESCRIPTION OF EXEMPLARY EMBODIMENTS

The exemplary embodiment explained below is a preferred embodiment of the invention. In the exemplary embodiment, the described components of the embodiment each represent individual features of an aspect of the invention that should be considered independently of one another, and that each also develop an aspect of the invention independently of one another and can therefore also be considered to be part of an aspect of the invention individually or in a combination other than that shown. Furthermore, the embodiment described can also be supplemented by further features of an aspect of the invention that have already been described.

In the figures, elements with the same function are each provided with the same reference numeral.

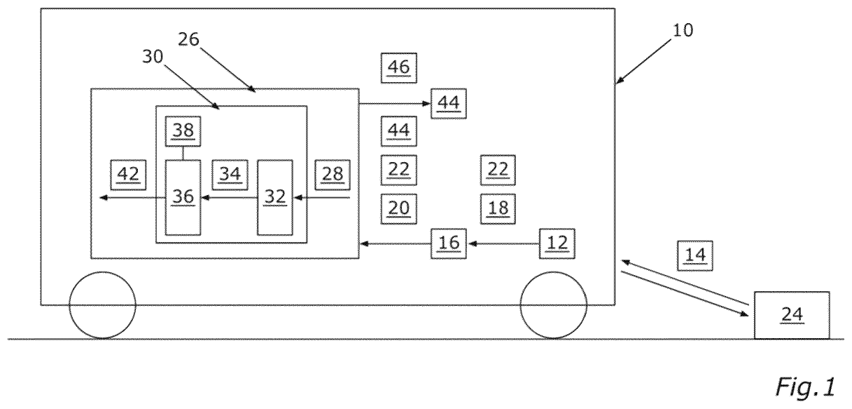

FIG. 1 shows a schematic representation of a vehicle which has a control device.

The vehicle 10 can have a radar device 12, which can be configured to emit radar signals 14 into an environment surrounding the vehicle 10 and to receive reflected radar signals 14 in a scanning cycle. The radar device 12 can be configured to provide radar raw data 18 of the respective scanning cycle to a radar tracker 16. The radar tracker 16 can be configured to identify, in the radar raw data 18 of the respective scanning cycle, a detection 22 which may be associated with a target object 24. The association can describe an association of the detection 22 with a detection track 40 of the target object 24. The radar tracker 16 can be configured to be able to track the target object 24 by identifying the respective detection 22 in the respective scanning cycles. The radar tracker 16 can be configured to provide the control device 26 with radar data 20 of the current scanning cycle, which comprise the detection 22 and the association of the detection 22 with the target object 24. The control device 26 is configured to receive the radar data 20 and to extract at least one predefined input feature 28 of the detection 22 from the radar data 20 of the current scanning cycle. The at least one predefined input feature 28 may comprise, for example, a radar cross-section of the detection 22 of the target object 24, a height of detection 22 above a ground, a model error of an elevation angle former or further input features 28 of a feature list.

The control device 26 is configured to provide a classification system 30 for the classification of the target object 24 on the basis of the detection 22. The classification system 30 has a feature generation model 32 and a classification model 36.

It is provided that the control device 26 sets up a respective classification entity of the classification system 30 for the respective target object 24. In other words, the respective classification entity can be associated with the detection track 40 of the target object 24. The control device 26 is configured to provide the input features 28, which are associated with the target object 24 in scanning cycles of the detection track 40, to the feature generation model 32 of the classification system 30. The feature generation model 32 is configured to update its internal state on the basis of the at least one input feature 28 of the current scanning cycle. By continuously updating the internal state of the feature generation model 32 on the basis of the input features 28 of the respective scanning cycles, a history of the input features 28 is represented by the internal state of the feature generation model 32.

It is provided that the feature generation model 32 of the classification system 30 is configured to update its internal state upon receiving the at least one input feature 28 of the current scanning cycle of the detection track 40 and to output at least one predetermined temporal feature 34 on the basis of the internal state and the at least one input feature 28 of the current scanning cycle. The control device 26 is configured to provide the at least one temporal feature 34 to the classification model 36. The classification model 36 of the classification system 30 is configured to output classification data 42 relating to an association of the target object 24 with at least one predefined output class 38 on the basis of the at least one temporal feature 34. There may for example be provision that three of the output classes 38 are predefined. One of the output classes 38 can reproduce target objects 24 which may be passed under, and another of the output classes 38 can reproduce target objects 24 which may be passed over. Another of the output classes 38 can reproduce target objects 24 which are obstacles. These may be target objects 24 that cannot be passed over and/or passed under.

The classification data 42 may indicate which of the output classes 38 the target object 24 is to be associated with and/or the probability with which the target object 24 is to be associated with the relevant output class 38. The classification model 36 is configured to output the classification data 42 relating to the association of the target object 24. The classification data 42 may be provided, for example, to a driver assistance apparatus 44 of the vehicle 10. The control device 26 may also be configured to output a control signal 46 on the basis of the classification data 42. The control signal 46 can be output, for example, if the target object 24 has a particular probability of being associated with a particular one of the output classes 38. It may be provided, for example, that the control signal 46 is output when the target object 24 is associated with the output class 38 that classifies the target object 24 as an obstacle with a probability above a certain limit value. As a result, the driver assistance apparatus can be controlled to output a warning signal.

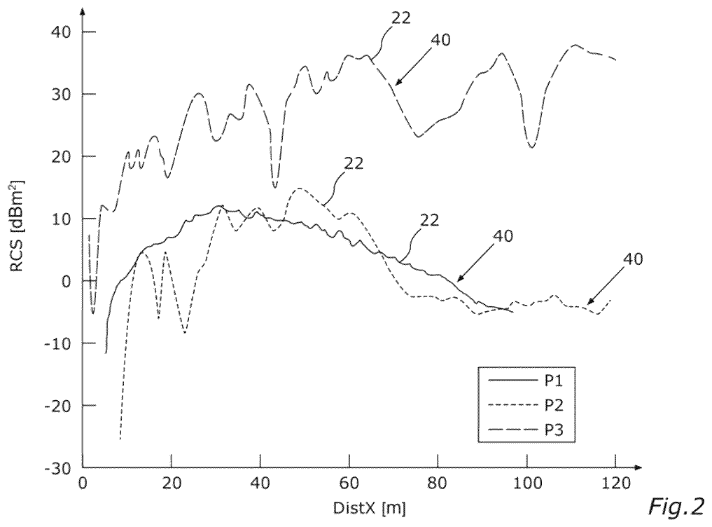

FIG. 2 shows a schematic representation of a course of radar cross-sections of different target objects over a distance.

The radar cross-section can be the at least one input feature 28, and can be determined for the respective scanning cycles. The target objects 24 may be an aluminum can, a Euro pallet and a car. It can be seen that the course of the radar cross-section of the target objects 24 changes characteristically over this distance.

The method previously used uses a linear function approximation to map the previously observed RCS measurement values of a target object 24. Features derived therefrom, such as the mean error and the gradient, can be used to generate a classification with respect to passability. The smaller the error, i.e. the better the linear approximation, the greater the probability that the observed target object 24 can be passed over. This is attributable to the characteristic of the multipath propagation of the electromagnetic waves. The exemplary RCS profiles of a target object 24 (aluminum can P1) which can be passed over, of a stationary obstacle with a low height (Euro pallet P2) and of a stationary obstacle (car P3) are depicted below. The limitation of the previously used method is that a lot of information is lost due to the approximation by means of a linear function. The remaining information content is fundamentally sufficient for separating between passable target objects 24 and obstacles, but the separation between passable target objects 24 and obstacles of low height is possible only to a limited extent. Through the use of the RNN as a feature generation model 32, it is possible to detect much more accurate temporal structures in the radar signals, which can be used by the NN as a classification model 36 in order to generate a classification with a much lower false classification rate.

The concept of an aspect of the invention provides for various input features 28 to be extracted from detections 22. These include, in addition to the radar cross section, also known as radar cross section (RCS), the height above ground (calculated from elevation angle and distance), as well as the installation position of a radar sensor of the radar device 12 and the model error of the elevation beamformer. Additional attributes can be added to the feature list. The feature generation model 32 processes these input features 28 and updates its internal state in the process. In this case, the internal state is a condensed representation of all input features 28 observed so far. The output of the feature generation model 32 is composed of processed temporal features 34. This output is dependent on the input features 28 on the one hand and on the internal state on the other hand. The processing of the input features 28 in the feature generation model 32 is determined by weight values of the individual neurons that have been determined in an offline learning process. The temporal features 34 are in turn the input signals for the classification model 36. This network serves as the actual classifier, mapping the temporal features 34 onto probabilities for the output classes 38.

Analogously to the feature generation model 32, the weights of the individual neurons used in the classification model 36 were also determined in an offline learning process. Since a detection 22 has no history, the existing “radar detection tracker” (RDT) is used to establish the temporal relationship between the detections 22 from different radar measurement cycles. In each case, one classification entity of the classification system 30 (feature generation model 32 plus classification model 36) is made available for each detection track 40.

The input features 28 for the classification of a detection track 40 are extracted here from the detection 22 which was also used for the update step in the radar tracker 16.

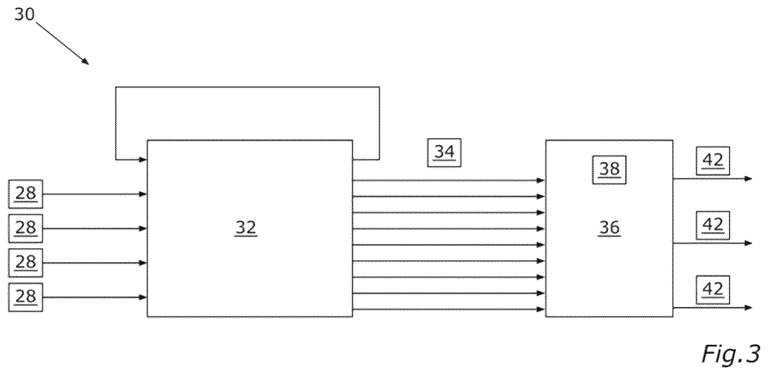

FIG. 3 shows a schematic representation of a classification system of the control device.

It shows the feature generation model 32 of the classification system 30, to which the input features 28 of the respective scanning cycles can be provided. The feature generation model 32 can update its internal state each time the input features 28 are received. In addition, after receiving the respective input features 28, the feature generation model 32 can generate the at least one predefined temporal feature 34 and output it to the classification model 36.

After receiving the at least one temporal feature 34 of the respective scanning cycle, the classification model 36 can determine the classification data 42 relating to the association of the target object 24 to the output classes 38. It may be provided, for example, that respective probability values are determined that describe the probability with which the target object 24 belongs to one of the output classes 38.

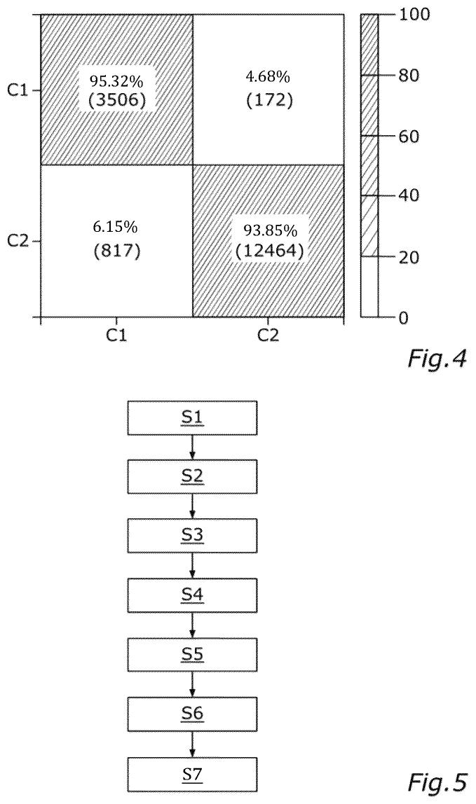

FIG. 4 shows a schematic representation of results of the classification model.

The described method was tested and validated in an experiment.

The experiment was structured as follows: Objective: Classification of the output classes 38 “passable over” (C1) and “obstacle” (C2), output class 38 “passable under” was not taken into account, output class 38 “obstacle” (C2) includes stationary road users, infrastructure, and “obstacles with low height”. The comparison with the method according to the prior art shows a significantly better classification performance with a significantly lower false classification rate. The results are shown in the confusion matrix.

FIG. 5 shows a schematic representation of a sequence of a method for providing classification data for classifying a target object on the basis of received radar signals.

The method can be carried out by means of a control device 26 such as the one shown for example in FIG. 1.

A first step S1 of the method can comprise receiving radar data 20 of a current scanning cycle of a detection track 40 which is associated with the target object 24. In other words, the control device 26 receives the radar data 20, which describe, for example, a detection 22 that has been detected in the current scanning cycle and is associated by the radar tracker 16 with the detection track 40, which is associated with the target object 24.

A second step S2 of the method can comprise extracting at least one predefined input feature 28 from the radar data 20 of the current scanning cycle.

A third step S3 may comprise providing the at least one input feature 28 of the current scanning cycle to a feature generation model 32 of a classification system 30 of a classification entity associated with the particular target object 24. The feature generation model 32 can be in an internal state which represents the at least one input feature 28 from preceding scanning cycles of the detection track 40. The feature generation model 32 may be configured to output at least one predefined temporal feature on the basis of the internal state and the at least one input feature 28 of the current scanning cycle.

A fourth step S4 may comprise updating the internal state of the feature generation model 32 on the basis of the at least one input feature 28 of the current scanning cycle.

A fifth step S5 may comprise determining the at least one temporal feature by means of the feature generation model 32.

A sixth step S6 may comprise providing the at least one temporal feature to a classification model 36 of the classification system 30, wherein the classification model 36 may be configured to output classification data 42 relating to an association of the target object 24 with at least one predefined output class 38 on the basis of the at least one temporal feature.

A seventh step S7 may comprise outputting the classification data 42 on the basis of the at least one temporal feature by means of the classification model 36.

An aspect of the invention uses a recurrent neural network (RNN) to approximate the history of the measured radar signals 14 of the target object 24 and to detect patterns in sequences. The input features 28 in this RNN are features from the so-called detection list. An already known radar detection tracker (RDT) is used to associate detections 22 of the same target object 24 from radar measurements at different times. The RNN processes this information as a temporal sequence, and stores relevant information as an internal state, and outputs temporal features at its output. The temporal features may thereupon be used by another neural network (NN) as an input signal in order to determine a prediction of the output class 38 of the measured detection. The output classes 38 can be defined as “passable over”, “obstacle” and “passable under”. Each of the output classes 38 is provided with a probability value for each prediction step, wherein a sum of the probabilities of the probability values always adds up to 100%.

In contrast to the prior art, a need to determine processed input features 28 is advantageously eliminated, whereby less manual effort is required from development engineers. The approximation of the history is much more precise, and it is therefore possible to detect more precise structures in the radar signals 14. As a result, the classification performance is higher, i.e. detections can be classified with a lower error rate. This in turn leads to potentially fewer malfunctions in the vehicle 10 and therefore to an improved system experience for the driver.

The method can be applied to other radar classification tasks which are likewise based on time series, such as for example pedestrian and cyclist classification. The described method may be able to process temporal sequences of radar data 20 at the detection level and to generate a classification with respect to the obstacle class “passable over”, “obstacle” or “passable under”. An association probability can be calculated for each of the classes. The sum of all probabilities should add up to 100%. The method is implemented by using a recurrent neural network (RNN) as the feature generation model 32 and a downstream neural network (NN) as the classification model 36.

The following steps are executed during a classification process of a single detection:
1. extracting the input features 28 from the detection 22 that was used for the update step in the radar tracker 16
2. calculating the secondary feature “height above ground”, wherein h is the height above ground, y is the elevation angle of the detection 22, the radial distance of the detection 22, and the vertical installation position of the radar device 12.
3. scaling all input features 28. The scaling factors have likewise been determined in an offline method on the basis of the training data.
4. generating the temporal features by processing the input features 28 in the feature generation model 32.
5. generating the classification data, which comprise probabilities of the target object 24 being associated with the output classes 38, by processing the temporal features 34 in the classification model 36.

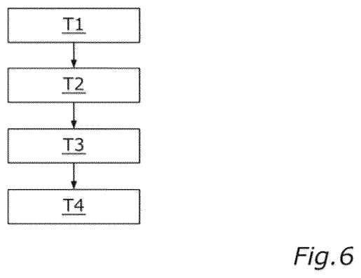

FIG. 6 shows a schematic representation of a method for training a classification system.

The method may comprise a method for training the feature generation model 32 and a method for training the classification model 36.

A first step T1 of the method for training the classification system 30 may comprise initializing all of the necessary variables and hyperparameters for the training of the feature generation model 32 and the classification model 36. This can include the number of epochs, learning rate, batch size, and other parameters.

A second step T2 may comprise the training of the feature generation model 32. This may comprise providing training input features and training temporal features for the feature generation model 32, using these data to update weights of the RNN using a gradient descent method, and repeating this process for a particular number of epochs or until the feature generation model 32 converges.

A third step T3 may comprise the training of the classification model 36. This may comprise providing the temporal features generated by the feature generation model 32 and the corresponding output classes 38 for the classification model 36, using these data to update weights of the classification model 36 by means of a gradient descent method, and repeating this process for a specific number of epochs or until the classification model 36 converges.

A fourth step T4 may comprise testing the classification system 30 based on new data. This may comprise providing the input features 28 for the feature generation model 32, generating temporal features 34 by means of the feature generation model 32, providing these temporal features 34 for the classification model 36, and outputting a prediction about the affiliation of the target object 24 to the various output classes 38.

Finally, the process of training and testing the classification system 30 may be repeated until appropriate accuracy and performance are achieved.

Overall, the example shows how a pass-over and pass-under classification of radar detections by means of sequence pattern recognition by recurrent neural networks can be provided.

### LIST OF REFERENCE NUMERALS

10 vehicle
12 radar device
14 radar signal
16 radar tracker
18 radar raw data
20 radar data
22 detection
24 target object
26 control device
28 Input feature
30 classification system
32 feature generation model
34 temporal feature
36 classification model
38 output class
40 detection track
42 classification data
44 driver assistance apparatus
46 control signal
C1, C2 output classes
P1-P3 profiles
S1-S6 method steps
T1-T4 method steps

1. A method for providing classification data (42) for the classification of a target object (24) on the basis of detection in received radar signals (14),
characterized in that
the method comprises the following steps carried out by a control device (26):
receiving the radar data (20) of a current scanning cycle, which comprise the detection of a detection track (40) which is associated with the target object (24);
extracting at least one predefined input feature (28) from the detection in the radar data (20) of the current scanning cycle;
providing the at least one input feature (28) of the current scanning cycle to a feature generation model (32) of a classification system (30), wherein the feature generation model (32) has an internal state which represents the at least one input feature (28) from previous scanning cycles of the detection track (40) and is configured to output, on the basis of the internal state and the at least one input feature (28) of the current scanning cycle, at least one predefined temporal feature;
updating the internal state of the feature generation model (32) on the basis of the at least one input feature (28) of the current scanning cycle;
determining the at least one temporal feature by means of the feature generation model (32);
providing the at least one temporal feature to a classification model (36) of the classification system (30), wherein the classification model (36) is configured to output classification data (42) relating to an association of the target object (24) with at least one predefined output class (38) on the basis of the at least one temporal feature; and
outputting the classification data (42) on the basis of the at least one temporal feature by means of the classification model (36).

2. The method according to claim 1,
characterized in that
the classification data (42) comprise respective probability values relating to a probability of an association of the target object (24) with the predefined output classes (38).

3. The method according to claim 1 or 2,
characterized in that
the feature generation model (32) is in the form of an artificial recurrent neural network.

4. The method according to any one of the preceding claims,
characterized in that
the classification model (36) is in the form of an artificial neural network.

5. The method according to any one of the preceding claims,
characterized in that
multiple of the input features (28) of the current scanning cycle are extracted from the radar data (20) of the current scanning cycle, and
the input features (28) are scaled according to respective scaling factors in the feature generation model (32).

6. The method according to any one of the preceding claims,
characterized in that
the at least one input feature (28) of the current scanning cycle comprises a radar cross-section of the detection.

7. The method according to any one of the preceding claims,
characterized in that
the at least one input feature (28) of the current scanning cycle comprises a height of detection (22) over a ground.

8. The method according to any one of the preceding claims,
characterized in that
the height above the ground is calculated according to the formula h=sin(γ)*r+p, wherein h is the height above the ground, γ is the elevation angle of the detection (22), r is the radial distance of the detection (22) and p is the vertical installation position of the radar device (12);

9. The method according to any one of the preceding claims,
characterized in that
a separate classification entity of the classification system (30) is used for each target object (24).

10. The method according to any one of the preceding claims,
characterized in that
the method comprises an output of a control signal (46) by the control device (26).

11. A method for training a classification system (30), comprising:
training a feature generation model (32), which is trained to output, on the basis of an internal state of the feature generation model (32) and at least one input feature (28), at least one predefined temporal feature (34); and
training a classification model (36), which is trained to output, on the basis of the at least one temporal feature (34), classification data (42) relating to an association of a target object (24) with at least one predetermined output class (38).

12. A storage device (26), which is configured to carry out a method according to any one of claims 1 to 10 and/or a method according to claim 11.

13. A program which comprises program instructions which, when executing the program instructions, cause a processor circuit to carry out an embodiment of a method according to any one of claims 1 to 10 and/or a method according to claim 11.

14. A data storage that comprises program instructions which, when executing the program instructions, prompt the processor circuit to carry out an embodiment of a method according to any one of claims 1 to 10 and/or of a method according to claim 11.
